(19) United States
(12) Patent Application Publication
(10) Pub. No.: US 2022/0275120 A1
(43) Pub. Date: Sep. 1, 2022

(54) PREPARATION OF LOW-DUSTING OR NON-DUSTING WATERDISPERSIBLE CROSSLINKED POLYVINYLPYRROLIDONE GRANULES

(71) Applicant: BASF SE, Ludwigshafen (DE)

(72) Inventors: Roland Hinrich Staff, Ludwigshafen (DE); Joerg Kress, Lampertheim (DE); Andreas Hasse, Ludwigshafen (DE)

(21) Appl. No.: 17/628,274

(22) PCT Filed: Aug. 4, 2020
(86) PCT No.: PCT/EP2020/071842

§ 371 Date: Jan. 19, 2022

(30) Foreign Application Priority Data
Aug. 5, 2019 (EP) 19189935.0

(51) Int. Cl. C08F 126/10; C08J 3/05

(52) U.S. Cl. CPC C08F 126/10; C08J 3/05; C08J 2339/06

(57) ABSTRACT

Preparation of low-dusting or dust-free waterdispersible crosslinked polyvinylpyrrolidone (PVPP) granules characterized by extruding a dough consisting of said PVPP and water through a die plate and subsequent drying of the granules.

This invention relates to the preparation of low-dusting or non-dusting waterdispersible crosslinked polyvinylpyrrolidone (PVPP) granules characterized by extruding a dough consisting of said PVPP and water through a die plate and subsequent drying of the granules.

PVPP has a variety of known uses. One such use is as a clarifying agent for alcoholic or nonalcoholic beverages. The use of the PVPPs as such a clarifying agent is due mainly to the ability of such material to remove phenolic and polyphenolic compounds such as anthocyanogens and other tannins and their oxidation products found in such beverages, but also to remove certain metal ions from such beverages.

In the beer industry where PVPP is valued as a polyphenol absorber, product performance is directly related to particle size. The work of McMurrough et al. (J Agricult Food Chem, 43, 10, 2687-2691, 1995) showed, that “the adsorptive capacity of commercial PVPP increased with decreasing particle size.”

Despite the wide use of PVPP in the beverage, cleaning, and pharmaceutical sciences arts, the PVPP powders possess some undesirable handling issues, specifically the potential for heavy dusting during the transfer of the PVPP powders.

There have been attempts to manufacture and supply a more “user friendly” PVPP product to the customer, e.g. PVPP with better powder properties.

WO2010/065603 outlines a process to make PVPP granules to overcome the issue of dusting. The process requires two steps: a compression step to form the coherent mass and a breaking step to break up the compressed composition into discrete pieces. The resultant granules are in the size range of about 200 to 1000 μm. This two-step process is less than ideal from a cost prospective. In addition, the breaking step has the potential to further damage the PVPP microstructure giving undesirable filtrate characteristics. In addition it seems that the granulation process can negatively affect the polyphenol removal capacity of the granulated PVPP as compared to the original powder as indicated by the disclosed statement that “granulated compositions retain 80% or more of the original polyphenol removal of the ungranulated feedstock”.

WO 2018064795 provides a dry, direct compressed tablet having minimal dusting and acceptable mechanical characteristics, comprising at least 70 wt.-% PVPP, more preferably at least 95 wt.-% PVPP. When these tablets are placed in a beverage to be treated, the disintegration properties of PVPP cause the tablets to quickly disintegrate to give the original powder PVPP. The resultant tablets are moisture sensitive and need a special and thus expensive packaging treatment. The disintegration takes 2 minutes 30 seconds.

The present invention relates to a method of producing low-dusting or non-dusting granules which show no moisture sensitivity, do not disintegrate during storage into smaller particles and are produced by extruding a dough consisting of said PVPP and water through a die plate, followed by drying of the granules.

In the recommended manner of operating, the PVPP powder and water are mixed in a certain ratio using a suitable mixer. The resulting dough has a water content of between 25 and 75 wt %, preferred between 30 to 70 wt %, more preferred between 40 to 65 wt-% and most preferred between 45 and 65 wt-%, and is extruded, preferred without any additional heating during the extrusion process through a die plate with diameters of a single hole ranging from 200 μm to 5 mm. Preferably the diameter is between 500 μm to 1 mm, most preferred is a diameter of 700 μm. The extrusion speed is chosen in a way to reach a constant material flow. The strings that are pressed out of the die plate disintegrate into compact, small granules either directly after die plate or after slight mechanical agitation such as shaking. These granules still contain the water amount chosen during the preparation of the dough. The granules are then transferred into a drying machine, such as an oven, a fluidized bed, a paddle drier or a belt drier or similar suitable equipment, whereby the fluidized bed dryer is preferred. In the drying machine they are dried until their relative humidity is between 10 wt-% and 2 wt-%.

The resulting granules are low- or non-dusting and free flowing, with said granules having a particle size of 500 μm in diameter and higher making up to 75% or more of said preparation, preferably said granules with a particle size of 500 μm in diameter and higher making up to 95% or more of said preparation. In a further elaborated embodiment of the low- or non-dusting and free flowing granules said granules in said preparation having a particle size of 850 μm in diameter or more make up to 10% or less, most preferred to 5% or less of said preparation. The diameter and particle size distribution of the granules is determined by sieve analysis dividing the granules into different size fractions (0-1000 μm).

The dried granules when placed into the beverage to be treated disintegrate within minutes to give PVPP powder. There is no difference in polyphenol absorption capacity observed for the PVPP granules and original PVPP powder. Treated beverages can be both aqueous and hydro alcoholic based and include for example beer and the like fermented products, wine, tea, fruit juice, vinegar and vegetable extracts. The dried granules can be used alone or in combination with other products.

The dust number of the dried granules lies between 70 and 0, preferred between 65 and 0, more preferred between 52 and 0 and most preferred between 10 and 0. For comparison the dust number of the PVPP powder, the raw material Divergan F was 108.

The dust number of the PVPP granules is determined with a dust measurement device (DustView II, Palas GmbH, Karlsruhe (Germany)). It consists of a funnel to fill in the material, a down pipe and a dust box with removeable dust cage. The components of dry materials that are dusting are measured quantitatively by optoelectronic means. The dusting material causes an attenuation of a light beam, which is measured photometrically. Both the measured values and the subsequent calculation are carried out by the instrument. It shows two values, one after 0.5 seconds (max-value) and the other after 30 seconds (dust-value). The dust number is the sum of max-value and dust value. The interpretation of the dust numbers is as follows:

Dust number 25 to or above 100: dusting to strongly dusting
Dust number 12 to 25: minor dusting to dusting
Dust number 8 to 12: hardly dusting
Dust number smaller than 8: hardly dusting to non-dusting

The invention will now be described with particular reference to the following non-limiting examples:

### EXAMPLES

### Example 1

Crosslinked PVPP as fine powder (Divergan F) and water are mixed thoroughly in a standard Lödige mixer (Lödige ploughshare mixer M5 RMK, speed set to 160 rpm with chopper, produced by Gebrüder Lödige Maschinenbau GmbH) in a weight-ratio of 35 to 65. The resulting dough is extruded at room temperature (20° C., 1013.25 mbar) in a dome extruder (DomeGranulator DG-L1, produced by Fuji Paudal Co.) through a die plate with a hole diameter of 0.7 mm at an extruder speed of 50 rpm. This results in strings that break into single granules directly, by falling down and/or slight mechanical agitation. The granules are then put into a polypropylene box and transferred into a standard lab oven operated at 50° C. After drying overnight, the granules consisted of at least 90% crosslinked PVPP. The granules are free-flowing and show nearly no dusting (dust number 13.8). Upon adding the granules to water at a concentration of 50 g per hL they quickly disintegrate into a fine suspension of PVPP particles in water. The granules show a catechin absorption of 67.6% whereas the ungranulated PVPP employed to make the granules show a catechin absorption of 67.0%.

### Example 2a

As example 1, but an extruder speed of 40 rpm was used and the drying did take place in a fluidized bed (Fluidizd bed Aeromatic Strea 1 by Aeromatic AG) operated at an air temperature of 50° C. The resulting granules were nearly non-dusting (dust number 10.6), free-flowing and very quickly disintegrated upon addition to water.

### Example 2b

As example 2a, but an extruder speed of 60 rpm was used. The resulting granules did not show differences compared to granules from Example 2a (dust number 13.4).

### Example 2c

As example 2a, but an extruder speed of 80 rpm was used. The resulting granules did not show differences compared to granules from Example 2a (dust number 6.4).

### Example 3a (not According to the Invention)

A ratio of PVPP to water of 80 to 20 was used. Otherwise, the same process as in example 1 but with an extruder speed of 40 rpm was employed. Granules with a significant number of fines (dust number 142) before a sieving step were obtained, the granules also break easily. The particle size distribution of the granules is displayed in Table 2.

### Example 3b

As example 3a, but with a ratio of PVPP to water of 75 to 25. The resulting granules show significant less fines and break less easily. The particle size distribution of the granules is displayed in Table 2.

### Example 3c

As example 3a, but with a ratio of PVPP to water of 70 to 30. The resulting granules do not dust much (dust number 64) and are stable. The particle size distribution of the granules is displayed in Table 2.

### Example 3d

As example 3a, but with a ratio of PVPP to water of 60 to 40. The resulting granules do not dust much (dust number 52) and are stable. The particle size distribution of the granules is displayed in Table 2.

### Example 3e

As example 3a, but with a ratio of PVPP to water of 50 to 50. The resulting granules do not dust (dust number 8.5) and are stable. The particle size distribution of the granules is displayed in Table 2.

### Example 3f

As example 3a, but with a ratio of PVPP to water of 65 to 35. The resulting granules do not dust (dust number 3.04) and are stable. The particle size distribution of the granules is displayed in Table 2.

### EXAMPLES NOT ACCORDING TO INVENTION

### Example 4

As example 3a, but with a ratio of PVPP to water of 100 to 0. No granules are obtained but rather the originally used PVPP powder.

### Example 5

As example 3a, but with a ratio of PVPP to water of 20 to 80. The resulting dough cannot be extruded as it is too wet.

The results of examples 1 to 5 are reported in Table 1

TABLE 1

| | PVPP | Water | Dust | Catechin | Extruder |
|---|---|---|---|---|---|
| Example | (wt-%) | (wt-%) | value | abs | speed |
| 1 | 35 | 65 | 13.8 | 67.6 | 50 |
| 2a | 35 | 65 | 10.6 | | 40 |
| 2b | 35 | 65 | 13.4 | | 60 |
| 2c | 35 | 65 | 6.4 | | 80 |
| 3a (not | 80 | 20 | 142 | | 40 |
| according to | | | | | |
| the invention) | | | | | |
| 3b | 75 | 25 | | | 40 |
| 3c | 70 | 30 | 64 | | 40 |
| 3d | 60 | 40 | 52 | | 40 |
| 3e | 50 | 50 | 8.5 | | 40 |
| 3f | 35 | 65 | 3.04 | | 40 |
| 4 (not | 100 | 0 | No granules | | 40 |
| according to | | | formed | | |
| the invention) | | | | | |
| 5 (not | 20 | 80 | Too wet, not | | |
| according to | | | extrudable | | |
| the invention) | | | | | |

### Analytical Tools:

Humidity measurements: Residual humidity was measured on a Mettler Toledo halogen dryer HR 73 by placing 1 g of a sample on the balance and dry it at 130° C. to until the mass changed less than 1 mg in cos.

Sieve analysis: For particle size distribution, a sieve analysis was carried out by placing 25 g of a sample on a Retsch vibration sieve machine AS 200 control g using sieves with a diameter of 200 mm. Subsequently, the sieves were vibrated for 10 minutes at an amplitude of 2.0 mm. For analysis, the sieves were weighted before and after vibration.

The results of the sieve analysis are reported in Table 2.

TABLE 2

| | Example 3a (not | | | | | |
|---|---|---|---|---|---|---|
| | according to | | | | | |
| | the invention) | Example 3b | Example 3c | Example 3d | Example 3e | Example 3f |
| Water in | 20.0% | 25.0% | 30.0% | 40.0% | 50.0% | 65.0% |
| dough | | | | | | |
| >1000 μm | 1.1% | 0% | 0% | 0% | 0% | 3.5% |
| >850 μm | 1.9% | 1.4% | 0% | 1.5% | 0% | 1% |
| >710 μm | 26.5% | 41% | 52.2% | 32.7% | 16.5% | 33.3% |
| >600 μm | 22.6% | 30.2% | 36.9% | 53% | 73.8% | 51.2% |
| >500 μm | 18.4% | 15.9% | 9.6% | 11.9% | 9.1% | 10.4% |
| >425 μm | 10.9% | 7.2% | 1.3% | 0.8% | 0.7% | 0.5% |
| >250 μm | 7.0% | 3.4% | 3.3% | 0% | 0% | 0% |
| >180 μm | 2.9% | 1.0% | 0% | 0% | 0% | 0% |
| >63 μm | 8.0% | 0% | 0% | 0% | 0% | 0% |
| >0 μm | 0.5% | 0% | 0% | 0% | 0% | 0% |

Catechin absorption: A beer model system, which contains the phenolic compound (+)-catechin in a 5% ethanol solution, is used as a relative measure of the absorptive capacity of the PPVP. The absorbance is measured at 280 nm against a solvent blank.

As reagents, absolute ethanol (DAB quality), dried (+)-catechin hydrate (e.g. Fluka, prod. no. 22110, drying process for catechin hydrate: 12 h in a vacuum dryer at 60° C. with subsequent determination of dry matter stored in a desiccator), ultrapure water, HPLC quality (Millipore treatment equipment) were employed. For the catechin solution 80 mg (based on dry matter) were transferred with 50 mL of ethanol into a 1 L volumetric flask, dissolved by heavy mixing, filled up with ultrapure water to the calibration mark and mix again. For the ethanol solution, 50 mL of ethanol were filled in a 1 L volumetric flask and filled up with ultrapure water to the calibration mark.

In all cases the dry matter of Divergan is determined for an exact calculation of the PVPP quantity, which is needed for the analysis. 50 mg of dry PVPP were weighted in a 150 mL beaker to form the blank. Subsequently, 100 mL ethanol solution were added into the beaker with the blank for a contact time of exactly five minutes. The suspension is filtered immediately through a glass filter type G3 (pore size 16-40 μm), or, for very fine PVPP a glass filter type G4 (pore size 10-16 μm) and measured against the 5% ethanol solution at 280 nm (EBL). To form the sample, 50 mg—under account of the dry matter—of the PVPP sample were weighted into a second beaker. Subsequently, 100 mL catechin solution were added to the sample and proceeded in the same way as with the blank sample (ESA). The “untreated” catechin solution was measured against the 5% ethanol solution at 280 nm. This value is referred to the basic content E100.

All solutions were measured in a 1 cm quartz cuvette in a standard UV-Vis spectrometer at 280 nm. The catechin adsorption is calculated by:

$$Catechin adsorption in \% = \frac{( E 100 - ( ESA - EBL ) )}{E 100} \times 100 \%$$

E100: extinction of the catechin solution
ESA: extinction of the sample
EBL: extinction of the blank

### Determination of Powder Flow Properties

Various glass funnels with a height of 90 mm, a slope angel of 30° and openings of 48 mm on the upper and 2.5, 5, 8, 12 and 18 mm on the lower end were filled to the brim with a representative sample of a given product while keeping the lower opening hole closed. Upon opening, the products flow out of the funnel. If the product does not flow, the next funnel with the next larger opening is taken and the procedure is repeated until one has identified the funnel the product flows through. Sample with very high flowability flow through the 2.5 mm funnel, samples with very bad flowability do not flow through the 18 mm funnel.

| Example | Funnel |
|---|---|
| Divergan F | 18 mm |
| (ungranulated PVPP) | |
| 3a | 8 mm |
| 3c | 8 mm |
| 3f | 8 mm |
| 1 | 8 mm |

1. A method of preparing low-dusting or non-dusting granules consisting of PVPP comprising extruding a dough consisting of said PVPP and water through a die plate and subsequent drying of the granules.

2. The method according to claim 1 having a residual humidity after drying of from 10 to 2 wt-%.

3. The method according to claim 1 having a dust number after drying of the granules of between 70 and 0.

4. The method according to claim 3 having a dust number after drying of between 65 and 0.

5. The method according to claim 4 having a dust number after drying of between 52 and 0.

6. The method according to claim 5 having a dust number after drying of between 10 and 0.

7. The method according to claim 1 wherein granules of 500 μm diameter and higher make up 75% or more of said preparation.

8. The method according to claim 7 wherein granules of 500 μm diameter and higher make up 95% or more of said preparation.

9. The method according to claim 7 wherein granules of 850 μm diameter and higher make up 10% or less of said preparation.

10. A method for producing low-dusting or non-dusting granules consisting of PVPP, comprising extruding a dough consisting of said PVPP and water, said dough having a water content of between 25 and 75 wt-% through a die plate, and subsequent drying of the granules.

11. The method according to claim 10 for producing low-dusting or non-dusting granules consisting of PVPP, comprising extruding a dough consisting of said PVPP and water, said dough having a water content of between 30 and 70 wt-% through a die plate, and subsequent drying of the granules.

12. The method according to claim 11 for producing low-dusting or non-dusting granules consisting of PVPP, comprising extruding a dough consisting of said PVPP and water, said dough having a water content of between 40 and 65 wt-% through a die plate, and subsequent drying of the granules.

13. The method according to claim 12 for producing low-dusting or non-dusting granules consisting of PVPP, comprising extruding a dough consisting of said PVPP and water, said dough having a water content of between 45 and 65 wt-% through a die plate, and subsequent drying of the granules.

14. The method according to claim 10, comprising extruding the dough consisting of said PVPP and water without additional heating.

15. A method of treating a beverage comprising (i) contacting the beverage with PVPP granules prepared according to claim 1, and (ii) subsequently filtering, settling, and/or centrifuging the beverage to remove the PVPP.
